(19) United States
(12) Patent Application Publication
(10) Pub. No.: US 2024/0228336 A1
(43) Pub. Date: Jul. 11, 2024

(54) METHOD FOR CONTROLLING POWER SUPPLIED TO OZONE WATER GENERATOR

(71) Applicant: Feng XU, Yantai (CN)

(72) Inventor: Jiang PENG, Yantai (CN)

(21) Appl. No.: 18/514,765

(22) Filed: Nov. 20, 2023

(30) Foreign Application Priority Data
Jan. 7, 2023 (TW) 112100704

(51) Int. Cl. C02F 1/461; C02F 1/467

(52) U.S. Cl. CPC C02F 1/46109; C02F 1/4672; C02F 2001/46133; C02F 2001/46157; C02F 2201/46135; C02F 2201/4616

(57) ABSTRACT

A method for controlling power supplied to an ozone water generator is disclosed. The ozone water generator includes an electrolytic plate unit. The electrolytic plate unit includes an anode plate assembly composed of a plurality of anode plates, a first cathode plate assembly composed of a plurality of first cathode plates, and a second cathode plate assembly composed of a plurality of second cathode plates. In the process of electrolyzing water, the two cathode plate assemblies alternately obtain a relatively high-level signal at a short time, and the two cathode plate assemblies obtain a relatively low-level signal at other times. During the use of the ozone water generator, the scale formed on the surface of the cathode plate assembly can be removed in time, so as to ensure the electrolysis performance of the ozone water generator, without descaling by chemicals. No maintenance is required.

### FIELD OF THE INVENTION

The present invention relates to a method for controlling power supplied to an ozone water generator, and belongs to the technical field of ozone generation by electrolyzing water.

### BACKGROUND OF THE INVENTION

Ozone can be generated under the action of an electric field and an anode catalyst by electrolyzing taper water. The electrolysis process is very complicated, and the mechanism of the electrolysis process is as follows:
the main reaction at the anode: 3H₂O=O₃+6H⁺+6e⁻
the side reaction at the anode: 2H₂O=O₂+4H⁺+4e⁻
the main reaction at the cathode: 2H⁺+2 e⁼H₂

Ozone generated by electrolysis is quickly dissolved and mixed into water to form ozone water. Ozone water has a very high oxidation potential, which can instantly react with organic matter in water and oxidize it to form a stable substance that is harmless to the human body. Therefore, ozone water can be used for water purification, disinfection and sterilization. In these days, the method of electrolyzing tap water to generate ozone water has been widely used in vegetable washing machines to remove pesticide residues, insect eggs and microorganisms in food and similar applications.

However, there are side reactions at the cathode in the process of electrolyzing tap water. Calcium and magnesium ions in water will be accumulated at the cathode, and scale will gradually form on the surface of the cathode. Scale is difficult to remove, especially in the case of poor water quality and a lot of scale accumulation, which will affect the electrolysis performance of the ozone water generator greatly. In general, the method to remove the scale uses chemicals or alternately changes the anode and the cathode intermittently in the process of electrolyzing water. In the method of using chemicals, the ozone water generator needs to be disassembled and soaked in the chemical solution, and then cleaned and assembled again. The maintenance is cumbersome and the user experience is poor. The method to remove the scale by alternately changing the anode and the cathode intermittently in the process of electrolyzing water is to control the power supplied to the ozone water generator. The gas generated in the process of alternately changing the anode and the cathode intermittently increases the internal pressure, and a gas discharge port is required. The equipment structure is complicated, and the cost increases. Moreover, the switching device for a power switch adopts a relay. Frequent switching may cause damage to the contacts of the relay easily due to ignition.

Obviously, the conventional ozone water generator has many deficiencies to be improved.

### SUMMARY OF THE INVENTION

The primary object of the present invention is to overcome the above-mentioned shortcomings of the prior art and to provide a method for controlling power supplied to an ozone water generator, so as to meet the application requirements of ozone water.

The technical solution provided by the present invention is described below: A method for controlling power supplied to an ozone water generator involves: in one cycle period during operation of the ozone water generator, supplying the power at a relatively high level to an anode plate assembly: in the same cycle period, supplying the power at a relatively low level to a first cathode plate assembly for TA seconds and then supplying the power at the relatively high level to the first cathode plate assembly for TB seconds before returning the power to the relatively low level: and, in the same cycle period, supplying the power at the relatively low level to the second plate assembly for “2TA+TB” seconds, and then supplying the power at the relatively high level to the second cathode plate assembly for TB seconds before returning the power to the relatively low level and starting a new cycle, wherein every cycle period takes “2TA+2 TB” seconds, with TB being smaller than “(⅘)*(TA+TB)” and greater than “( 1/15)*(TA+TB)”.

Preferably, TA+TB=30 seconds, TB=5 seconds.

The ozone water generator comprises an electrolytic water tank, a power supply control circuit unit and a flow switch that are connected to one another. The electrolytic water tank includes a housing and a top cover hermetically connected on top of the housing. The top cover has a water inlet and a water outlet. An electrolytic plate unit is provided inside the housing. The electrolytic plate unit includes the anode plate assembly composed of a plurality of anode plates, the first cathode plate assembly composed of a plurality of first cathode plates, and the second cathode plate assembly composed of a plurality of second cathode plates. The first cathode plates are perforated titanium plates or perforated stainless steel plates. The second cathode plates are titanium plates or stainless steel plates. The anode plates are titanium anode plates doped with tin dioxide. The anode plates of the anode plate assembly are electrically connected to one another. The first cathode plates of the first cathode plate assembly are electrically connected to one another. The second cathode plates of the second cathode plate assembly are electrically connected to one another. The anode plate assembly is connected to an anode conductive sheet. An anode conductive post is connected to the anode conductive sheet. The first cathode plate assembly is connected to a first cathode conductive sheet. A first cathode conductive post is connected to the first cathode conductive sheet. The second cathode plate assembly is connected to a second cathode conductive sheet. A second cathode conductive post is connected to the second cathode conductive sheet. The anode conductive post, the first cathode conductive post and the second cathode conductive post pass through the housing of the electrolytic water tank and are electrically connected to the power supply control circuit unit. A bottom plate isolation seat is provided on an inner side of a bottom of the housing. A corresponding top plate isolation seat is provided on an inner side of a top of the top cover. Upper and lower ends of the first cathode plate assembly, the second cathode plate assembly and the anode plate assembly are inserted into the top plate isolation seat and the bottom plate isolation seat, respectively.

Furthermore, the electrolytic plate unit includes the anode plate assembly composed of n the anode plates, the first cathode plate assembly composed of 2n the first cathode plates, and the second cathode plate assembly composed of two the second cathode plates. n is an integer, n≥1. The first cathode plates and the anode plates are arranged alternately and spaced apart from one another. The second cathode plates are placed outside the outermost first cathode plates, respectively.

Furthermore, the electrolytic plate unit includes the anode plate assembly composed of n the anode plates, the first cathode plate assembly composed of 2n the first cathode plates, and the second cathode plate assembly composed of n+1 the second cathode plates. n is an integer, n≥1. The first cathode plates, the second cathode plates and the anode plates are arranged in sequence and spaced apart from one another.

Furthermore, the power supply control circuit unit includes a single-chip microcomputer module, a power supply module and an electrolytic plate control circuit unit that are connected to one another. The flow switch is connected to the signal input terminal of the single-chip microcomputer module. The power input terminal of the power supply module is connected to the mains electricity. The power supply module has two outputs, one is to output 5V stabilized voltage to the single-chip microcomputer module to supply power to the single-chip microcomputer module, and the other is to output a constant current to supply power to the electrolytic plate control circuit unit. The positive electrode of the constant current output of the power supply module is connected to respective ends of the resistor R1, the resistor R2 and the resistor R3 as well as the source of the P-channel MOS transistor P1, the source of the P-channel MOS transistor P2, and the source of the P-channel MOS transistor P3. The other ends of the resistor R1, the resistor R2 and the resistor R3 are connected to the gate of the P-channel MOS transistor P1, the gate of the P-channel MOS transistor P2, and the gate of the P-channel MOS transistor P3, respectively. The gate of the P-channel MOS transistor P1, the gate of the P-channel MOS transistor P2 and the gate of the P-channel MOS transistor P3 are further connected to the drain of the N-channel MOS transistor MN1, the drain of the N-channel MOS transistor MN2 and the drain of N-channel MOS transistor MN3, respectively. The gate of the N-channel MOS transistor N1 and the gate of the N-channel MOS transistor N2 are connected to the gate of the P-channel MOS transistor P2 and the gate of the P-channel MOS transistor P3, respectively. The drain of the N-channel MOS transistor N1 and the drain of the N-channel MOS transistor N2 are connected to the drain of the P-channel MOS transistor P2 and the drain of the P-channel MOS transistor P3, respectively. The negative electrode of the constant current output of the power supply module is connected to the source of the N-channel MOS transistor MN1, the source of the N-channel MOS transistor MN2, the source of the N-channel MOS transistor MN3, the source of the N-channel MOS transistor N1, and the source of the N-channel MOS transistor N2. The gate of the N-channel MOS transistor MN1, the gate of the N-channel MOS transistor MN2 and the gate of the N-channel MOS transistor MN3 are connected to the control output terminal of the single-chip microcomputer module. The drain of the P-channel MOS transistor P1 is connected to the anode conductive post outside the bottom of the housing of the electrolytic water tank. The drain of the P-channel MOS transistor P2 and the drain of the N-channel MOS transistor N1 are connected to the first cathode conductive post outside the bottom of the housing of the electrolytic water tank. The drain of the P-channel MOS transistor P3 and the drain of the N-channel MOS transistor N2 are connected to the second cathode conductive post outside the bottom of the housing of the electrolytic water tank.

A method for controlling power supplied to the ozone water generator comprises the following steps:

Step 1: The electrolytic water tank and the flow switch are installed on the water supply pipe, and the water source and the power supply are turned on. During standby, the control output terminal of the single-chip microcomputer module supplies a relatively low-level signal to the gate of the N-channel MOS transistor MN1, the gate of the N-channel MOS transistor MN2, and the gate of the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly 112 and the second cathode plate assembly 113 are connected to the constant current output terminal V− of the power supply module. The anode plate assembly is disconnected from the constant current output terminal V+ of the power supply module. The electrolytic plate unit has no power supply. The ozone water generator is in a stop working state.

Step 2: When using water, the flow switch is closed. The signal input terminal of the single-chip microcomputer module obtains the signal that the flow switch is closed. The control output terminal of the single-chip microcomputer module supplies a relatively high-level signal to the gate of the N-channel MOS transistor MN1, and supplies a relatively low-level signal to the gate of the N-channel MOS transistor MN2 and the gate of the N-channel MOS transistor MN3. The N-channel MOS transistor MN1 is on. The N-channel MOS transistor MN2 and the N-channel MOS transistor MN3 are cut off. The P-channel MOS transistor P1 is on. The P-channel MOS transistor P2 and the P-channel MOS transistor P3 are cut off. The N-channel MOS transistor N1 and the N-channel MOS transistor N2 are on. The anode plate assembly is connected to the constant current output terminal V+ of the power supply module. The first cathode plate assembly and the second cathode plate assembly are connected to the constant current output terminal V− of the power supply module. The ozone water generator forms an electrolytic power supply circuit via the anode plate assembly, the first cathode plate assembly and the second cathode plate assembly, and starts to electrolyze water to generate ozone water. After the time TA, preferably, 25 seconds, the control output terminal of the single-chip microcomputer module supplies a relatively high-level signal to the gate of the N-channel MOS transistor MN2. The P-channel MOS transistor P2 is on. The N-channel MOS transistor N1 is cut off. The first cathode plate assembly is connected to the constant current output terminal V+ of the power supply module. The ozone water generator forms an electrolytic power supply circuit via the anode plate assembly and the second cathode plate assembly, and starts to electrolyze water to generate ozone water. At the same time, the first cathode plate assembly and the second cathode plate assembly form another power supply circuit. The scale formed on the first cathode plate assembly falls off under the action of the electric field. After the time TB, preferably, 5 seconds, the control output terminal of the single-chip microcomputer module supplies a relatively low-level signal to the gate of the N-channel MOS transistor MN2. The P-channel MOS transistor P2 is cut off. The N-channel MOS transistor N1 is on. The first cathode plate assembly is connected to the constant current output terminal V− of the power supply module. The ozone water generator forms an electrolytic power supply circuit via the anode plate assembly, the first cathode plate assembly and the second cathode plate assembly, and continues to electrolyze water to generate ozone water. After the time TA, the control output terminal of the single-chip microcomputer module supplies a relatively high-level signal to the gate of the N-channel MOS transistor MN3. The N-channel MOS transistor N2 is cut off. The P-channel MOS transistor P3 is on. The second cathode plate assembly and the anode plate assembly are connected to the constant current output terminal V+ of the power supply module. The first cathode plate assembly is connected to the constant current output terminal V− of the power supply module. The ozone water generator forms an electrolytic power supply circuit via the anode plate assembly and the first cathode plate assembly, and continues to electrolyze water to generate ozone water. At the same time, the second cathode plate assembly and the first cathode plate assembly form another power supply circuit. The scale formed on the second cathode plate assembly falls off under the action of the electric field. After the time TB, preferably, 5 seconds, the control output terminal of the single-chip microcomputer module supplies a relatively low-level signal to the gate of the N-channel MOS transistor MN3. The P-channel MOS transistor P3 is cut off. The N-channel MOS transistor N2 is on. The second cathode plate assembly is connected to the constant current output terminal V− of the power supply module. The ozone water generator forms an electrolytic power supply circuit via the anode plate assembly, the first cathode plate assembly and the second cathode plate assembly, and continues to electrolyze water to generate ozone water. The afore-mentioned actions are repeated to start the next cycle.

Step 3: When the water is stopped, the flow switch is disconnected. The signal input terminal of the single-chip microcomputer module obtains the signal that the flow switch is disconnected. The control output terminal of the single-chip microcomputer module supplies a relatively low-level signal to the gates of the N-channel MOS transistor MN1, the N-channel MOS transistor MN2 and the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly and the second cathode plate assembly are connected to the constant current output terminal V− of the power supply module. The anode plate assembly is disconnected from the constant current output terminal V+ of the power supply module. The electrolytic plate unit has no power supply. The ozone water generator is in a standby state.

The beneficial effect of the present invention is described below. Two cathode plate assemblies are provided in the present invention. In the working process, the method of the present invention is that the two cathode plate assemblies alternately obtain a relatively high-level signal at a short time in the process of electrolyzing water, and the two cathode plate assemblies obtain a relatively low-level signal at other times. During the use of the ozone water generator, the scale formed on the surface of the cathode plate assembly can be removed in time, so as to ensure the electrolysis performance of the ozone water generator, without descaling by chemicals. No maintenance is required, and the user experience is good. The scale can be removed simultaneously during the working process. The generated gas is discharged with the water flow, so there is no need for an additional gas discharge port. The control circuit uses a field effect transistor as the switching device of the power switch. It can realize high-speed switching because it has no contact. The invention has the advantages of simple structure, stable operation and good descaling effect.

### BRIEF DESCRIPTION OF THE DRAWINGS

FIG. 1 is a structural block diagram of the ozone water generator of the present invention:

FIG. 2 is a cross-sectional view of the water tank of the ozone water generator of the present invention:

FIG. 3 is a perspective view of the electrolytic plate unit of the ozone water generator of the present invention:

FIG. 4 is a cross-sectional view of another implementation of the water tank of the ozone water generator of the present invention:

FIG. 5 is a perspective view of another implementation of the electrolytic plate unit of the ozone water generator of the present invention:

FIG. 6 is a schematic diagram of the control circuit of the present invention; and

FIG. 7 is a waveform diagram of the anode plate assembly, the first cathode plate assembly, the second cathode plate assembly and the flow switch in the working process.

### DETAILED DESCRIPTION OF THE PREFERRED EMBODIMENTS

Embodiments of the present invention will now be described, by way of example only, with reference to the accompanying drawings.

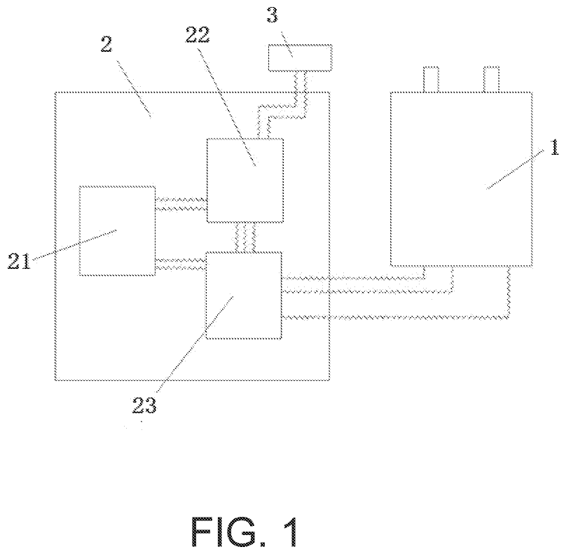

As shown in FIG. 1, an ozone water generator comprises an electrolytic water tank 1, a power supply control circuit unit 2 and a flow switch 3 that are connected to one another.

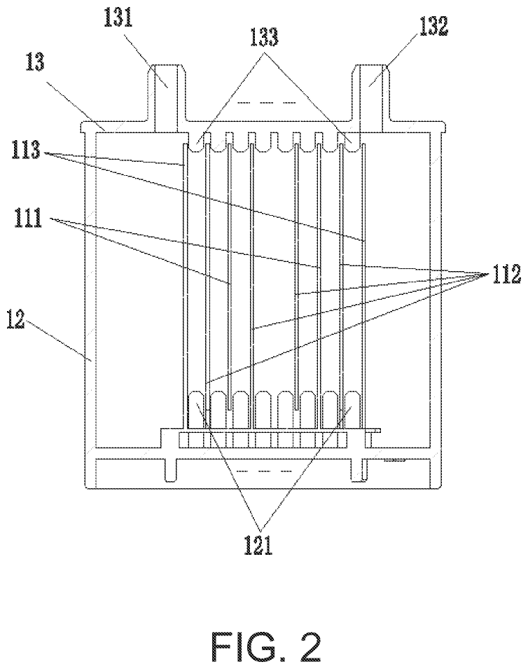

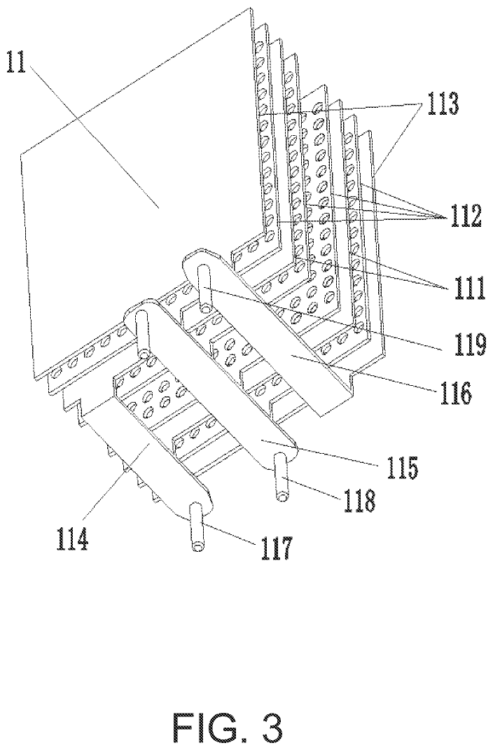

As shown in FIG. 2 and FIG. 3, the electrolytic water tank 1 includes a housing 12 and an electrolytic plate unit 11 inside the housing 12. The electrolytic plate unit 11 includes an anode plate assembly 111 composed of n anode plates, a first cathode plate assembly 112 composed of 2n first cathode plates, and a second cathode plate assembly 113 composed of two second cathode plates. n is an integer, n≥1. In this embodiment, n=2, that is, the anode plate assembly 111 is composed of two anode plates, the first cathode plate assembly 112 is composed of four first cathode plates, and the second cathode plate assembly 113 is composed of two second cathode plates. The first cathode plates and the anode plates are arranged alternately and spaced apart from one another. The second cathode plates are placed outside the outermost first cathode plates, respectively. The first cathode plates of the first cathode plate assembly 112 are perforated titanium plates or perforated stainless steel plates. The second cathode plates of the second cathode plate assembly 113 are titanium plates or stainless steel plates. The anode plates of the anode plate assembly 111 are titanium anode plates doped with tin dioxide. The anode plates of the anode plate assembly 111 are connected to an anode conductive sheet 114. An anode conductive post 117 is provided on the underside of the anode conductive sheet 114. The anode conductive post 117 passes through the bottom of the housing 12 of the electrolytic water tank 1. The first cathode plates of the first cathode plate assembly 112 are connected to a first cathode conductive sheet 115. A first cathode conductive post 118 is provided on the underside of the first cathode conductive sheet 115. The first cathode conductive post 118 passes through the bottom of the housing 12 of the electrolytic water tank 1. The second cathode plates of the second cathode plate assembly 113 are connected to a second cathode conductive sheet 116. A second cathode conductive post 119 is provided on the underside of the second cathode conductive sheet 116. The second cathode conductive post 119 passes through the bottom of the housing 12 of the electrolytic water tank 1. A top cover 13 of the electrolytic water tank 1 is hermetically connected to the top of the housing 12. The top cover 13 has a water inlet 131 and a water outlet 132. A bottom plate isolation seat 121 is provided on the inner side of the bottom of the housing 12. A corresponding top plate isolation seat 133 is provided on the inner side of the top of the top cover 13. The upper and lower ends of the first cathode plates, the second cathode plates and the anode plates are respectively inserted into the top plate isolation seat and the bottom plate isolation seat to realize electrical isolation and avoid a short circuit of the adjacent anode and cathode plates.

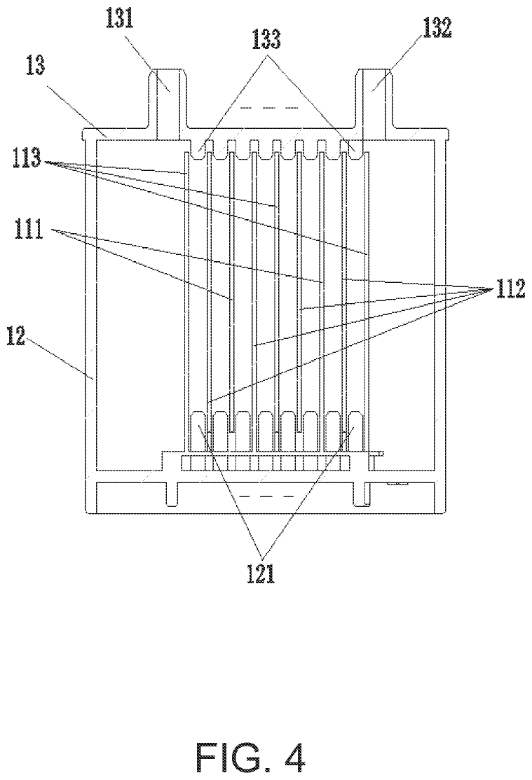

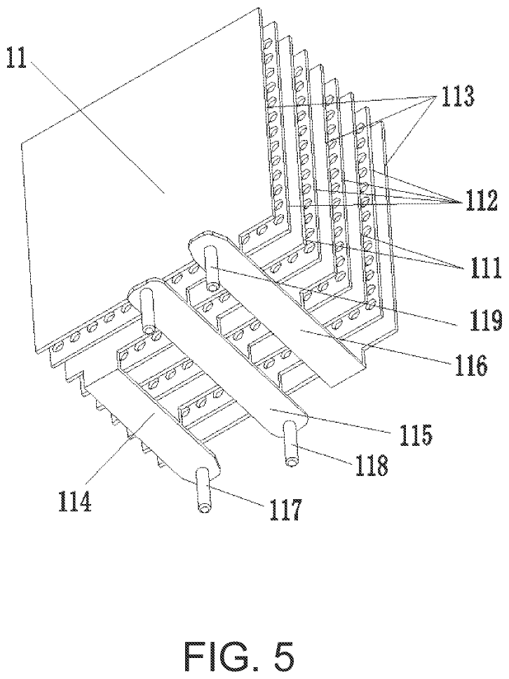

As shown in FIG. 4 and FIG. 5, in order to further improve the descaling effect, the electrolytic plate element unit 11 includes an anode plate assembly 111 composed of n anode plates, a first cathode plate assembly 112 composed of 2n first cathode plates, and a second cathode assembly 113 composed of n+1 second cathode plates. n is an integer, n≥1. In this embodiment, n=2, that is, the anode plate assembly 111 is composed of two anode plates, the first cathode plate assembly 112 is composed of four first cathode plates, and the second cathode plate assembly 113 is composed of three second cathode plates. The first cathode plates, the second cathode plates and the anode plates are arranged in sequence and spaced apart from one another.

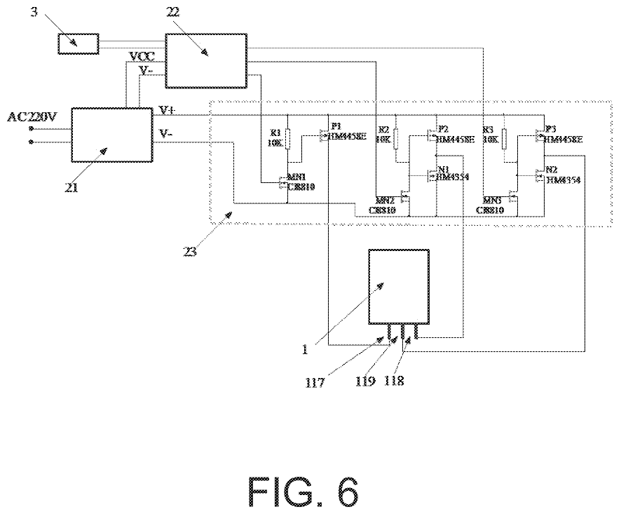

As shown in FIG. 6, the power supply control circuit unit 2 includes a single-chip microcomputer module 22, a power supply module 21 and an electrolytic plate control circuit unit 23 that are connected to one another. The flow switch 3 is connected to the signal input terminal of the single-chip microcomputer module 22. The power input terminal of the power supply module 21 is connected to the mains electricity. The power supply module 21 has two outputs, one is to output 5V stabilized voltage to the single-chip microcomputer module 22 to supply power to the single-chip microcomputer module 22, and the other is to output a constant current to supply power to the electrolytic plate control circuit unit 23. The positive electrode of the constant current output of the power supply module 21 is connected to respective ends of the resistor R1, the resistor R2 and the resistor R3 as well as the source of the P-channel MOS transistor P1 (HM4458E), the source of the P-channel MOS transistor P2 (HM4458E), and the source of the P-channel MOS transistor P3 (HM4458E). The other ends of the resistor R1, the resistor R2 and the resistor R3 are connected to the gate of the P-channel MOS transistor P1, the gate of the P-channel MOS transistor P2, and the gate of the P-channel MOS transistor P3, respectively. The gate of the P-channel MOS transistor P1, the gate of the P-channel MOS transistor P2 and the gate of the P-channel MOS transistor P3 are further connected to the drain of the N-channel MOS transistor MN1 (CJ8810), the drain of the N-channel MOS transistor MN2 (CJ8810) and the drain of N-channel MOS transistor MN3 (CJ8810), respectively. The gate of the N-channel MOS transistor N1 (HM4354) and the gate of the N-channel MOS transistor N2 (HM4354) are connected to the gate of the P-channel MOS transistor P2 and the gate of the P-channel MOS transistor P3, respectively. The drain of the N-channel MOS transistor N1 and the drain of the N-channel MOS transistor N2 are connected to the drain of the P-channel MOS transistor P2 and the drain of the P-channel MOS transistor P3, respectively. The negative electrode of the constant current output of the power supply module 21 is connected to the source of the N-channel MOS transistor MN1, the source of the N-channel MOS transistor MN2, the source of the N-channel MOS transistor MN3, the source of the N-channel MOS transistor N1, and the source of the N-channel MOS transistor N2. The gate of the N-channel MOS transistor MN1, the gate of the N-channel MOS transistor MN2 and the gate of the N-channel MOS transistor MN3 are connected to the control output terminal of the single-chip microcomputer module 22. The drain of the P-channel MOS transistor P1 is connected to the anode conductive post 117 outside the bottom of the housing 12 of the electrolytic water tank 1. The drain of the P-channel MOS transistor P2 and the drain of the N-channel MOS transistor N1 are connected to the first cathode conductive post 118 outside the bottom of the housing 12 of the electrolytic water tank 1. The drain of the P-channel MOS transistor P3 and the drain of the N-channel MOS transistor N2 are connected to the second cathode conductive post 119 outside the bottom of the housing 12 of the electrolytic water tank 1.

A method for controlling power supplied to the ozone water generator of the present invention involves: in one cycle period during operation of the ozone water generator, supplying the power at a relatively high level to the anode plate assembly 111: in the same cycle period, supplying the power at a relatively low level to the first cathode plate assembly 112 for TA seconds and then supplying the power at the relatively high level to the first cathode plate assembly 112 for TB seconds before returning the power to the relatively low level: and, in the same cycle period, supplying the power at the relatively low level to the second plate assembly 113 for “2TA+TB” seconds, and then supplying the power at the relatively high level to the second cathode plate assembly 113 for TB seconds before returning the power to the relatively low level and starting a new cycle.

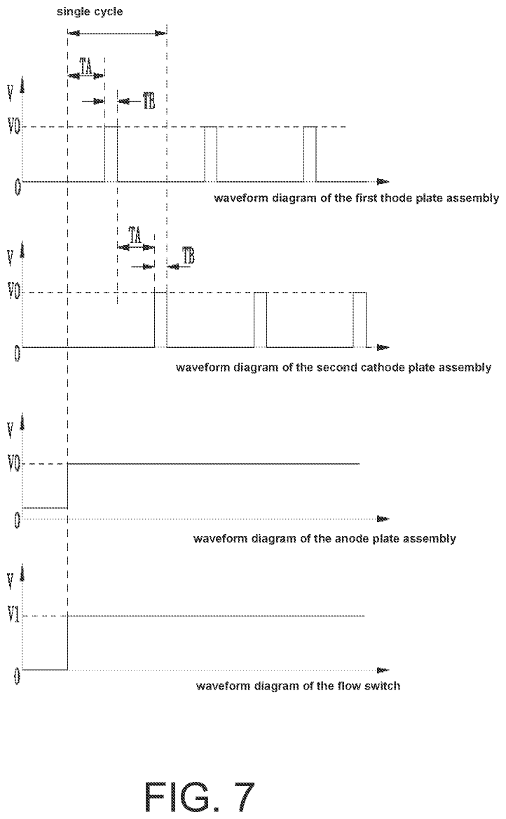

Every cycle period takes “2TA+2 TB” seconds, with TB being smaller than “(⅘)*(TA+TB)” and greater than “( 1/15)*(TA+TB)”. Preferably, “TA+TB”=30 seconds, and TB=5 seconds. FIG. 7 is a waveform diagram of the anode plate assembly, the first cathode plate assembly, the second cathode plate assembly and the flow switch in the working process.

The implementation of the present invention includes the following steps:

Step 1: The electrolytic water tank 1 and the flow switch 3 are installed on the water supply pipe, and the water source and the power supply are turned on. During standby, the control output terminal of the single-chip microcomputer module 22 supplies a relatively low-level signal to the gate of the N-channel MOS transistor MN1, the gate of the N-channel MOS transistor MN2, and the gate of the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly 112 and the second cathode plate assembly 113 are connected to the constant current output terminal V− of the power supply module 21. The anode plate assembly 111 is disconnected from the constant current output terminal V+ of the power supply module 21. The electrolytic plate unit has no power supply, and the ozone water generator is in a stop working state.

Step 2: When using water, the flow switch 3 is closed. The signal input terminal of the single-chip microcomputer module 22 obtains the signal that the flow switch 3 is closed. The control output terminal of the single-chip microcomputer module 22 supplies a relatively high-level signal to the gate of the N-channel MOS transistor MN1, and supplies a relatively low-level signal to the gate of the N-channel MOS transistor MN2 and the gate of the N-channel MOS transistor MN3. The N-channel MOS transistor MN1 is on. The N-channel MOS transistor MN2 and the N-channel MOS transistor MN3 are cut off. The P-channel MOS transistor P1 is on. The P-channel MOS transistor P2 and the P-channel MOS transistor P3 are cut off. The N-channel MOS transistor N1 and the N-channel MOS transistor N2 are on. The anode plate assembly 111 is connected to the constant current output terminal V+ of the power supply module 21. The first cathode plate assembly 112 and the second cathode plate assembly 113 are connected to the constant current output terminal V− of the power supply module 21. The ozone water generator forms an electrolytic power supply circuit via the anode plate assembly 111, the first cathode plate assembly 112 and the second cathode plate assembly 113, and starts to electrolyze water to generate ozone water. After the time TA, preferably, 25 seconds, the control output terminal of the single-chip microcomputer module 22 supplies a relatively high-level signal to the gate of the N-channel MOS transistor MN2. The P-channel MOS transistor P2 is on. The N-channel MOS transistor N1 is cut off. The first cathode plate assembly 112 is connected to the constant current output terminal V+ of the power supply module 21. The ozone water generator forms an electrolytic power supply circuit via the anode plate assembly 111 and the second cathode plate assembly 113, and starts to electrolyze water to generate ozone water. At the same time, the first cathode plate assembly 112 and the second cathode plate assembly 113 form another power supply circuit. The scale formed on the first cathode plate assembly 112 falls off under the action of the electric field. After the time TB, preferably, 5 seconds, the control output terminal of the single-chip microcomputer module 22 supplies a relatively low-level signal to the gate of the N-channel MOS transistor MN2. The P-channel MOS transistor P2 is cut off. The N-channel MOS transistor N1 is on. The first cathode plate assembly 112 is connected to the constant current output terminal V− of the power supply module 21. The ozone water generator forms an electrolytic power supply circuit via the anode plate assembly 111, the first cathode plate assembly 112 and the second cathode plate assembly 113, and continues to electrolyze water to generate ozone water. After the time TA, the control output terminal of the single-chip microcomputer module 22 supplies a relatively high-level signal to the gate of the N-channel MOS transistor MN3. The N-channel MOS transistor N2 is cut off. The P-channel MOS transistor P3 is on. The second cathode plate assembly 113 and the anode plate assembly 111 are connected to the constant current output terminal V+ of the power supply module 21. The first cathode plate assembly 112 is connected to the constant current output terminal V− of the power supply module 21. The ozone water generator forms an electrolytic power supply circuit via the anode plate assembly 111 and the first cathode plate assembly 112, and continues to electrolyze water to generate ozone water. At the same time, the second cathode plate assembly 113 and the first cathode plate assembly 112 form another power supply circuit. The scale formed on the second cathode plate assembly 113 falls off under the action of the electric field. After the time TB, preferably, 5 seconds, the control output terminal of the single-chip microcomputer module 22 supplies a relatively low-level signal to the gate of the N-channel MOS transistor MN3. The P-channel MOS transistor P3 is cut off. The N-channel MOS transistor N2 is on. The second cathode plate assembly 113 is connected to the constant current output terminal V− of the power supply module 21. The ozone water generator forms an electrolytic power supply circuit via the anode plate assembly 111, the first cathode plate assembly 112 and the second cathode plate assembly 113, and continues to electrolyze water to generate ozone water. The afore-mentioned actions are repeated to start the next cycle. As shown in FIG. 7, V0 is equal to the voltage between V+ and V−, and V1 is equal to the voltage between VCC and V−.

Step 3: When the water is stopped, the flow switch 3 is disconnected. The signal input terminal of the single-chip microcomputer module 22 obtains the signal that the flow switch 3 is disconnected. The control output terminal of the single-chip microcomputer module 22 supplies a relatively low-level signal to the gates of the N-channel MOS transistor MN1, the N-channel MOS transistor MN2 and the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly 112 and the second cathode plate assembly 113 are connected to the constant current output terminal V− of the power supply module 21. The anode plate assembly 111 is disconnected from the constant current output terminal V+ of the power supply module 21. The electrolytic plate unit has no power supply. The ozone water generator is in a standby state.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method for controlling power supplied to an ozone water generator involving: in one cycle period during operation of the ozone water generator, supplying the power at a relatively high level to an anode plate assembly: in the same cycle period, supplying the power at a relatively low level to a first cathode plate assembly for TA seconds and then supplying the power at the relatively high level to the first cathode plate assembly for TB seconds before returning the power to the relatively low level; and, in the same cycle period, supplying the power at the relatively low level to the second plate assembly for “2TA+TB” seconds, and then supplying the power at the relatively high level to the second cathode plate assembly for TB seconds before returning the power to the relatively low level and starting a new cycle, wherein every cycle period takes “2TA+2 TB” seconds, with TB being smaller than “(⅘)*(TA+TB)” and greater than “( 1/15)*(TA+TB)”.

2. The method as claimed in claim 1, wherein TA+TB=30 seconds, TB=5 seconds.

3. The method as claimed in claim 1, wherein the ozone water generator comprises an electrolytic water tank, a power supply control circuit unit and a flow switch that are connected to one another: the electrolytic water tank includes a housing and a top cover hermetically connected on top of the housing, the top cover has a water inlet and a water outlet, an electrolytic plate unit is provided inside the housing, the electrolytic plate unit includes the anode plate assembly composed of a plurality of anode plates, the first cathode plate assembly composed of a plurality of first cathode plates, and the second cathode plate assembly composed of a plurality of second cathode plates: the first cathode plates are perforated titanium plates or perforated stainless steel plates, the second cathode plates are titanium plates or stainless steel plates, the anode plates are titanium anode plates doped with tin dioxide: the anode plate assembly is connected to an anode conductive sheet, an anode conductive post is connected to the anode conductive sheet: the first cathode plate assembly is connected to a first cathode conductive sheet, a first cathode conductive post is connected to the first cathode conductive sheet: the second cathode plate assembly is connected to a second cathode conductive sheet, a second cathode conductive post is connected to the second cathode conductive sheet: the anode conductive post, the first cathode conductive post and the second cathode conductive post pass through the housing of the electrolytic water tank and are electrically connected to the power supply control circuit unit: a bottom plate isolation seat is provided on an inner side of a bottom of the housing, a corresponding top plate isolation seat is provided on an inner side of a top of the top cover, upper and lower ends of the first cathode plate assembly, the second cathode plate assembly and the anode plate assembly are inserted into the top plate isolation seat and the bottom plate isolation seat, respectively.

4. The method as claimed in claim 3, wherein the electrolytic plate unit includes the anode plate assembly composed of n the anode plates, the first cathode plate assembly composed of 2n the first cathode plates, and the second cathode plate assembly composed of two the second cathode plates, wherein n is an integer, n≥1: the first cathode plates and the anode plates are arranged alternately and spaced apart from one another, and the second cathode plates are placed outside the outermost first cathode plates, respectively.

5. The method as claimed in claim 3, wherein the electrolytic plate unit includes the anode plate assembly composed of n the anode plates, the first cathode plate assembly composed of 2n the first cathode plates, and the second cathode plate assembly composed of n+1 the second cathode plates, wherein n is an integer, n≥1: the first cathode plates, the second cathode plates and the anode plates are arranged in sequence and spaced apart from one another.

6. The method as claimed in claim 3, wherein the power supply control circuit unit includes a single-chip microcomputer module, a power supply module and an electrolytic plate control circuit unit that are connected to one another. The flow switch is connected to the signal input terminal of the single-chip microcomputer module. The power input terminal of the power supply module is connected to the mains electricity. The power supply module has two outputs, one is to output 5V stabilized voltage to the single-chip microcomputer module to supply power to the single-chip microcomputer module, and the other is to output a constant current to supply power to the electrolytic plate control circuit unit. The positive electrode of the constant current output of the power supply module is connected to respective ends of the resistor R1, the resistor R2 and the resistor R3 as well as the source of the P-channel MOS transistor P1 (HM4458E), the source of the P-channel MOS transistor P2 (HM4458E), and the source of the P-channel MOS transistor P3 (HM4458E). The other ends of the resistor R1, the resistor R2 and the resistor R3 are connected to the gate of the P-channel MOS transistor P1, the gate of the P-channel MOS transistor P2, and the gate of the P-channel MOS transistor P3, respectively. The gate of the P-channel MOS transistor P1, the gate of the P-channel MOS transistor P2 and the gate of the P-channel MOS transistor P3 are further connected to the drain of the N-channel MOS transistor MN1 (CJ8810), the drain of the N-channel MOS transistor MN2 (CJ8810) and the drain of N-channel MOS transistor MN3 (CJ8810), respectively. The gate of the N-channel MOS transistor N1 (HM4354) and the gate of the N-channel MOS transistor N2 (HM4354) are connected to the gate of the P-channel MOS transistor P2 and the gate of the P-channel MOS transistor P3, respectively. The drain of the N-channel MOS transistor N1 and the drain of the N-channel MOS transistor N2 are connected to the drain of the P-channel MOS transistor P2 and the drain of the P-channel MOS transistor P3, respectively. The negative electrode of the constant current output of the power supply module is connected to the source of the N-channel MOS transistor MN1, the source of the N-channel MOS transistor MN2, the source of the N-channel MOS transistor MN3, the source of the N-channel MOS transistor N1, and the source of the N-channel MOS transistor N2. The gate of the N-channel MOS transistor MN1, the gate of the N-channel MOS transistor MN2 and the gate of the N-channel MOS transistor MN3 are connected to the control output terminal of the single-chip microcomputer module. The drain of the P-channel MOS transistor P1 is connected to the anode conductive post outside the bottom of the housing of the electrolytic water tank. The drain of the P-channel MOS transistor P2 and the drain of the N-channel MOS transistor N1 are connected to the first cathode conductive post outside the bottom of the housing of the electrolytic water tank. The drain of the P-channel MOS transistor P3 and the drain of the N-channel MOS transistor N2 are connected to the second cathode conductive post outside the bottom of the housing of the electrolytic water tank.

7. The method as claimed in claim 3, wherein the implementation of the present invention includes the following steps:
Step 1: The electrolytic water tank and the flow switch are installed on the water supply pipe, and the water source and the power supply are turned on. During standby, the control output terminal of the single-chip microcomputer module supplies a relatively low-level signal to the gate of the N-channel MOS transistor MN1, the gate of the N-channel MOS transistor MN2, and the gate of the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly and the second cathode plate assembly are connected to the constant current output terminal V− of the power supply module. The anode plate assembly is disconnected from the constant current output terminal V+ of the power supply module. The electrolytic plate unit has no power supply, and the ozone water generator is in a stop working state.
Step 2: When using water, the flow switch is closed. The signal input terminal of the single-chip microcomputer module obtains the signal that the flow switch is closed. The control output terminal of the single-chip microcomputer module supplies a relatively high-level signal to the gate of the N-channel MOS transistor MN1, and supplies a relatively low-level signal to the gate of the N-channel MOS transistor MN2 and the gate of the N-channel MOS transistor MN3. The N-channel MOS transistor MN1 is on. The N-channel MOS transistor MN2 and the N-channel MOS transistor MN3 are cut off. The P-channel MOS transistor P1 is on. The P-channel MOS transistor P2 and the P-channel MOS transistor P3 are cut off. The N-channel MOS transistor N1 and the N-channel MOS transistor N2 are on. The anode plate assembly is connected to the constant current output terminal V+ of the power supply module. The first cathode plate assembly and the second cathode plate assembly are connected to the constant current output terminal V− of the power supply module. The ozone water generator forms an electrolytic power supply circuit via the anode plate assembly, the first cathode plate assembly and the second cathode plate assembly, and starts to electrolyze water to generate ozone water. After the time TA, preferably, 5 seconds, the control output terminal of the single-chip microcomputer module supplies a relatively high-level signal to the gate of the N-channel MOS transistor MN2. The P-channel MOS transistor P2 is on. The N-channel MOS transistor N1 is cut off. The first cathode plate assembly is connected to the constant current output terminal V+ of the power supply module. The ozone water generator forms an electrolytic power supply circuit via the anode plate assembly and the second cathode plate assembly, and starts to electrolyze water to generate ozone water. At the same time, the first cathode plate assembly and the second cathode plate assembly form another power supply circuit. The scale formed on the first cathode plate assembly falls off under the action of the electric field. After the time TB, preferably, 5 seconds, the control output terminal of the single-chip microcomputer module supplies a relatively low-level signal to the gate of the N-channel MOS transistor MN2. The P-channel MOS transistor P2 is cut off. The N-channel MOS transistor N1 is on. The first cathode plate assembly is connected to the constant current output terminal V− of the power supply module. The ozone water generator forms an electrolytic power supply circuit via the anode plate assembly, the first cathode plate assembly and the second cathode plate assembly, and continues to electrolyze water to generate ozone water. After the time TA, the control output terminal of the single-chip microcomputer module supplies a relatively high-level signal to the gate of the N-channel MOS transistor MN3. The N-channel MOS transistor N2 is cut off. The P-channel MOS transistor P3 is on. The second cathode plate assembly and the anode plate assembly are connected to the constant current output terminal V+ of the power supply module. The first cathode plate assembly is connected to the constant current output terminal V− of the power supply module. The ozone water generator forms an electrolytic power supply circuit via the anode plate assembly and the first cathode plate assembly, and continues to electrolyze water to generate ozone water. At the same time, the second cathode plate assembly and the first cathode plate assembly form another power supply circuit. The scale formed on the second cathode plate assembly falls off under the action of the electric field. After the time TB, preferably, 5 seconds, the control output terminal of the single-chip microcomputer module supplies a relatively low-level signal to the gate of the N-channel MOS transistor MN3. The P-channel MOS transistor P3 is cut off. The N-channel MOS transistor N2 is on. The second cathode plate assembly is connected to the constant current output terminal V− of the power supply module. The ozone water generator forms an electrolytic power supply circuit via the anode plate assembly, the first cathode plate assembly and the second cathode plate assembly, and continues to electrolyze water to generate ozone water. The afore-mentioned actions are repeated to start the next cycle. V0 is equal to the voltage between V+ and V−, and V1 is equal to the voltage between VCC and V−.
Step 3: When the water is stopped, the flow switch is disconnected. The signal input terminal of the single-chip microcomputer module obtains the signal that the flow switch is disconnected. The control output terminal of the single-chip microcomputer module supplies a relatively low-level signal to the gates of the N-channel MOS transistor MN1, the N-channel MOS transistor MN2 and the N-channel MOS transistor MN3. The N-channel MOS transistor MN1, the N-channel MOS transistor MN2 and the N-channel MOS transistor MN3 are cut off. The P-channel MOS transistor P1, the P-channel MOS transistor P2 and the P-channel MOS transistor P3 are cut off. The N-channel MOS transistor N1 and the N-channel MOS transistor N2 are on. The first cathode plate assembly and the second cathode plate assembly are connected to the constant current output terminal V− of the power supply module. The anode plate assembly is disconnected from the constant current output terminal V+ of the power supply module. The electrolytic plate unit has no power supply. The ozone water generator is in a standby state.
